(19) United States
(12) Patent Application Publication
(10) Pub. No.: US 2017/0252242 A1
(43) Pub. Date: Sep. 7, 2017

(54) MEDICAL CHAIR

(71) Applicant: Reliance Medical Products, Mason, OH (US)

(72) Inventors: Robert N. Young, Cincinnati, OH (US); Gregory F. Bellamah, Cincinnati, OH (US); Vladimir M. Rivlin, Mason, IN (US)

(21) Appl. No.: 15/450,392

(22) Filed: Mar. 6, 2017

Related U.S. Application Data
(60) Provisional application No. 62/303,793, filed on Mar. 4, 2016.

(51) Int. Cl. A61G 7/015; A61G 7/018; A61G 13/06; A61G 13/00; A61G 13/08; A61G 13/12; A47C 17/16; A61G 7/012; A47C 1/037

(52) U.S. Cl. CPC A61G 7/015; A61G 7/012; A61G 7/018; A61G 13/06; A47C 1/037; A61G 13/08; A61G 13/121; A61G 13/125; A47C 17/163; A61G 13/0018

(57) ABSTRACT

A medical chair having a plurality of adjustable positions includes a seat, a platform configured to support the seat, and a pillar. The pillar includes nested supports, in which a first one of the supports is fixedly coupled to the platform and a second one of the supports is operatively coupled to the seat, wherein the nested supports extend telescopically as the seat is positioned with respect to the platform. A linked cable carrier is located within a housing, wherein the housing extends from the base toward the seat and is disposed adjacently to the pillar. A leg rest and a back are each pivotably coupled to seat. A seat position actuator is centrally located on the seat and a leg rest actuator and a back actuator are located on opposite sides of the seat position actuator.

### CROSS-REFERENCE TO RELATED APPLICATION

This application claims priority to U.S. Provisional Patent Application Ser. No. 62/303,793 entitled “Surgical Support Surface”, filed Mar. 4, 2016, the disclosure of which is herein incorporated by reference in its entirety.

### TECHNICAL FIELD

The present teachings are generally related to a surgical support surface including a medical chair or table, and more particularly to a medical chair or table that may be repositioned to a plurality of positions.

### BACKGROUND

Lift and recline chairs of the type used, for example, during medical, dental and optical examinations and procedures are known in the prior art. Many times, these chairs are power operated by electric motors or hydraulic motors and may be moved vertically with respect to a base and/or reclined to place the patient in a recumbent or supine position. The chair is moved by the operator, i.e., the doctor, dentist or other medical professional, by way of a plurality of switches which may be attached to the chair itself or made part of a separate switch panel or foot switch assembly. Although various improvements have been made over the years in the switches and control systems for operating such powered adjustable chairs, certain problems and undesirable aspects associated with past designs have become apparent.

### SUMMARY

The present invention generally relates to movable chairs such as medical examination chairs and, more particularly, relates to a movable chair utilizing a control system having a control button layout with a plurality of buttons that may send commands to a controller or directly to an actuator to reposition the chair as desired by the user.

In one embodiment, there is provided a medical chair having a plurality of adjustable positions including a platform configured to support the medical chair, a seat operatively connected to the platform, a leg rest pivotably coupled to the seat, and a back pivotably coupled to the seat. A pillar includes a plurality of supports, in which a first one of the supports is fixedly coupled to the platform and a second one of the supports is operatively coupled to the seat, wherein in a first position of the seat with respect to the platform, the plurality of supports are nested to position the seat at a lowest height and in a second position the plurality of supports are extended to position the seat at a highest height. A leg rest actuator is rotatably coupled to the leg rest. A back actuator is rotatably coupled to back rest. A seat position actuator is fixedly coupled to one of the plurality of supports of the pillar and is rotatably coupled to the seat.

In another embodiment, there is provided a medical chair having a plurality of adjustable positions including a seat and a platform configured to support the seat. A pillar includes a plurality of nested supports, in which a first one of the supports is fixedly coupled to the platform and a second one of the supports is operatively coupled to the seat, wherein the nested supports extend telescopically as the seat is positioned with respect to the platform. A linked cable carrier is located within a housing, wherein the housing extends from the platform toward the seat and is disposed adjacently to the pillar.

### BRIEF DESCRIPTION OF THE DRAWINGS

The above-mentioned aspects of the present invention and the manner of obtaining them will become more apparent and the invention itself will be better understood by reference to the following description of the embodiments of the invention, taken in conjunction with the accompanying drawings, wherein:

FIG. 1 is a front perspective view of a medical chair.

FIG. 2 is a rear perspective view of a medical chair.

FIG. 3 is an elevational side view of a medical chair.

FIG. 4 is a perspective view of latch configured to lock and unlock a position of an arm rest.

FIG. 5a is a perspective view of a latch in an extended position to lock the position of an arm rest.

FIG. 5b is perspective view of a latch in a released position to enable movement of an arm rest.

FIG. 6 is a perspective view of components located beneath a seat of one side a medical chair.

FIG. 7 is a perspective view of components located beneath a seat of another side a medical chair.

FIG. 8 a layout of control buttons configured to adjust a position of a medical chair.

FIG. 9 is an elevational front view of a medical chair.

FIG. 10 is a rear perspective view of a medical chair.

FIG. 11 is an elevational rear view of a medical chair.

FIG. 12 is an elevational side view of a medical chair.

FIG. 13 is an elevational side view of a medical chair in with a head portion located at a same plane as a seat portion.

FIG. 14 is an elevational side view of a medical chair in a Trendelenburg position.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In this regard, the invention is illustrated in the several figures, and is of sufficient complexity that the many parts, interrelationships, and sub-combinations thereof simply cannot be clearly or meaningfully illustrated in a single patent-type drawing. Accordingly, several of the drawings show in schematic, or omit, parts that are not essential in that drawing to a description of a particular feature, aspect or principle of the invention being disclosed. Thus, the best mode of one embodied feature may be shown in one drawing, and the best mode of another feature will be called out in another drawing.

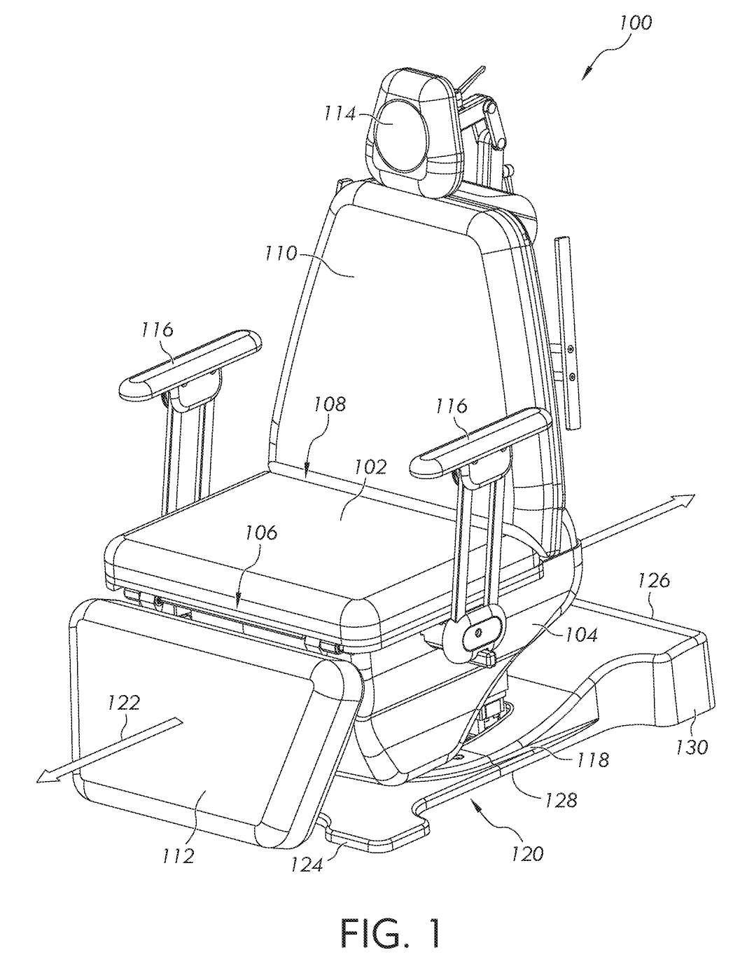

A movable chair 100 is shown in FIG. 1. The chair 100 may have a seat 102 coupled to a base 104. The seat 102 may be a portion of the chair 100 that is substantially level relative to the ground and sized and positioned to allow a user to sit thereon. While the seat 102 has been described as being level to the ground, this disclosure is not limited to such a configuration. Rather, the seat may have any angular orientation relative to the ground that still allows a user to sit thereon. In one non-exclusive example, the seat 102 may be slightly angled relative to the ground.

The base 104 may be coupled to a platform 118 that is sized to allow the chair 100 to be positioned on an underlying surface. The platform 118 may provide for sufficient support to maintain the desired orientation of the seat 102 and other components coupled thereto while the chair 100 is repositioned relative to the underlying surface. In one non-exclusive example, the platform 118 may extend from underneath a front portion 106 of the seat 102 rearward past a rear portion 108 of the seat 102. Further, the platform 118 may extend far enough past the rear portion 108 of the seat 102 to substantially maintain contact with the underlying surface as the chair 100 moves to different positions. In other words, the platform 118 extends far enough away from the rear portion 108 of the seat 102 to prohibit the chair 100 from falling over backwards.

The platform 118 includes a contoured edge 120 which extends along a longitudinal axis 122 of the chair 100. The platform includes a first end 124 toward the front of the chair 100 and a second end 126 toward the rear of the chair 100. A first portion 128 of the platform 118 is located more closely to the longitudinal axis 122 than a second portion 130 is located to the longitudinal axis. In addition, the second portion 130 is raised with respect to the rest of the platform 118.

The chair 100 may also have a back 110 pivotally coupled to the base 104 at the rear portion 108 of the seat 102. The back 110 may provide support for the user's back and shoulders when the user sits in the chair 100. Further, the chair 100 may also have a leg rest 112 pivotally coupled to the front portion 106 of the seat 102. The leg rest 112 and back 110 may be repositionable relative to the seat 102 to manipulate the angle of the user's legs, torso, and back relative to one another.

Similarly, the chair 100 may have a headrest 114 positioned at one end of the back 110. The headrest 114 may be movably coupled to the back 110 to allow the headrest 114 to be positioned in a plurality of different orientations relative to the back 110. Further, armrests 116 may be coupled to the base 104 at each side of the seat 102. The armrests 116 may also be repositionable between a raised and a lowered position.

Each of the armrests 116, headrest 114, back 110, seat 102, and leg rest 112 may be a structural member with a padding element coupled thereto via material upholstery. The respective structural members may dictate the positioning of the respective component while the padding element and the material upholstery may be positioned to increase user comfort.

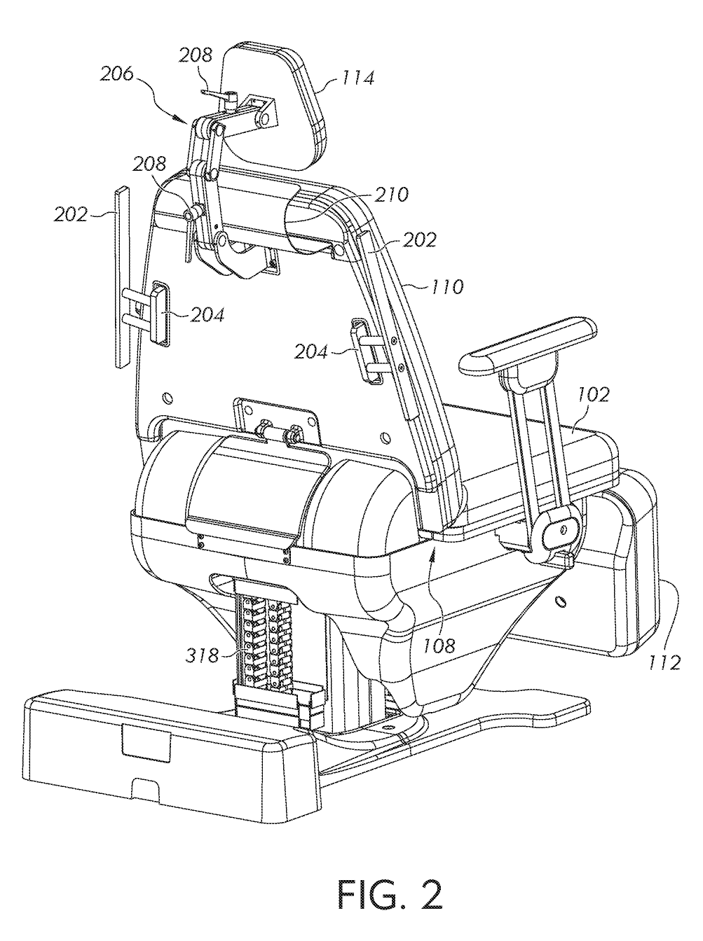

Referring now to FIG. 2, a back view of the chair 100 is shown. In the back view of the chair 100, at least one rail 202 is shown coupled to the back 110. The rail 202 may be coupled to the back via a rail mount 204 and extend partially between the rear portion 108 and the headrest 114. The headrest 114 may be coupled to the back 110 with a linkage 206. The headrest 114 may be selectively repositioned through the linkage 206 by engaging clamp arms 208. When the clamp arms 208 are in a disengaged position, the headrest 114 may be repositioned by pivoting about the joints of the linkage 206. When the position of the headrest 114 is at a desired location, the clamp arms 208 may be engaged to substantially restrict the linkage 206 from pivoting about the joints. Accordingly, the position of the headrest 114 relative to the back 110 depends on the engagement of the clamp arms 208 of the linkage 206.

Also shown in FIG. 2 is a roll holder 210. The roll holder 210 may be coupled to the back 110 at a lower portion and extend away from the back 110 to form a substantially 180 degree arc. The roll holder 210 may terminate at a location between the headrest 114 and the back 110. In one embodiment, a paper roll may be positioned within the roll holder 210 to allow the paper roll to be extended between the back 110 and the headrest 114 to cover the back 110, seat 102, and/or leg rest 112 of the chair 100.

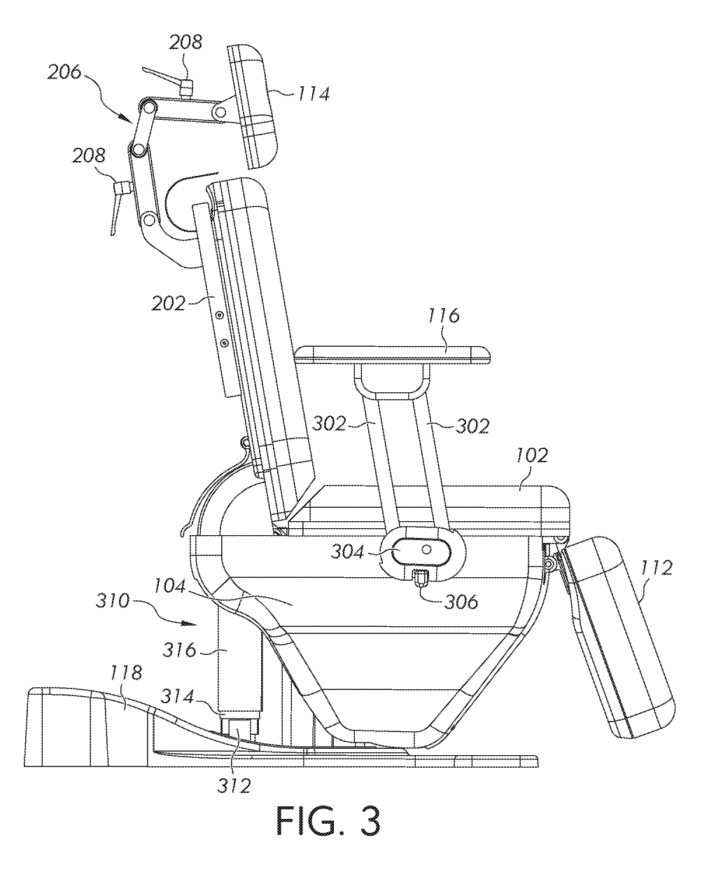

Now referring to FIG. 3, an elevated side view of the chair 100 is shown. Also shown in FIG. 3 is a support member 302 extending from a pivot housing 304 to the arm rest 116. In one embodiment, there may be two support members 302 extending between the arm rest 116 and the pivot housing 304. The two support members 302 may be substantially parallel to, and spaced from, one another. Further, each of the two support members 302 may be pivotable at either end.

The pivot housing 304 may also have a latch 306 for selectively locking the two support members 302, and in turn the arm rest 116, in the raised position shown in FIG. 3. The pivot housing 304 may have one or more springs positioned therein to bias the latch 306 towards a lock position. When the arm rest 116 is in the raised position, the latch 306 may substantially restrict the support members 302 from pivoting to any other orientation.

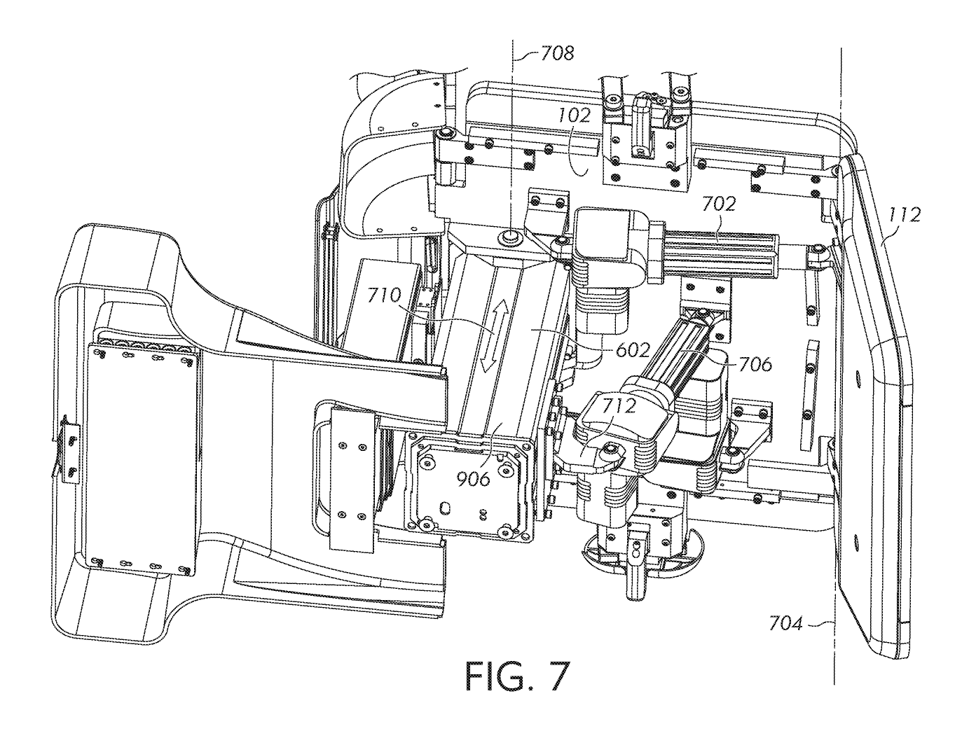

A housing 310 extends from the platform 118 and includes a first housing piece 312, a second housing piece 314, and third housing piece 316. The housing 310 extends telescopically with the pillar 602 as described in FIG. 7. A linked cable carrier 318 is located within the housing and extends with the housing as the seat 100 is elevated. See FIG. 2.

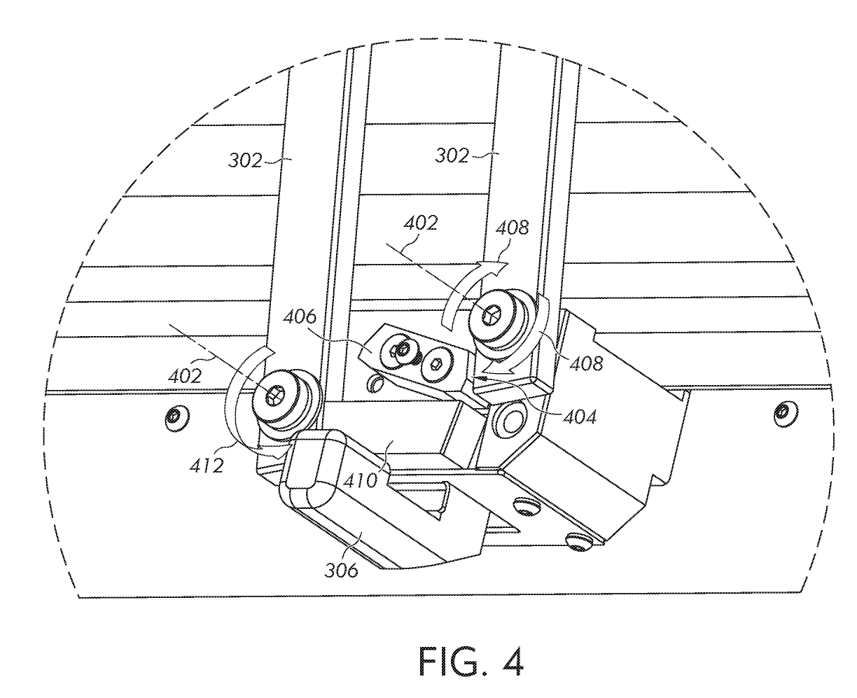

Referring now to FIG. 4, the latch 306 is shown with a cover removed from the pivot housing 304. More specifically, each support member 302 may be pivotable about a support axis 402. A pivot stop 406 may be positioned along one end of the support member 302 positioned towards the front portion 106 of the chair 100. The support member 302 may pivot about the support axis 402 in the raised direction indicated by arrow 408 until it contacts a contact surface 404 of the pivot stop 406. When the support member 302 contacts the pivot stop 406, the arm rests 116 may be in the fully raised position. Further still, once the arm rests 116 are in the fully raised position, a locking block 410 may interfere with the rotation of the support member 302 towards the rear portion 108 thereby restricting the support member 302 from pivoting in a lower direction 412 about the respective support axis 402. Further still, the latch 306 may be selectively engageable by the user to slide the locking block 410 out of interference with the support member 302 thereby allowing the arm rest 116 to become disposed in a lowered position.

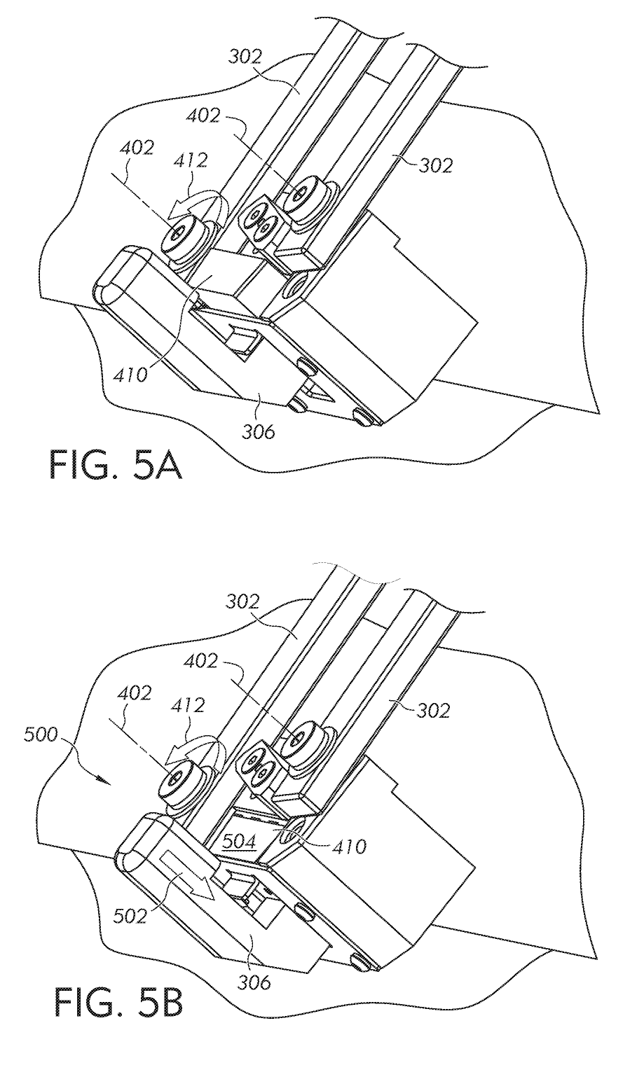

The movement of the locking block 410 may be more clearly shown with reference to FIG. 5a and FIG. 5b. More specifically, referring to FIG. 5a, the locking block 410 is shown in an extended position, thereby interfering with the rotation of the rearward support member 302 in the lowered direction indicated by arrow 412. In the embodiment shown in FIG. 5a, the arm rests 116 may be substantially locked in the raised position. In one embodiment, the locking block 410 may be biased in the extended position with one or more springs positioned between the locking block 410 and the pivot housing 304

Alternatively, in FIG. 5b the locking block 410 is shown in a released position 500. The locking block 410 may become disposed in the released position when a user applies a force to the latch 306 in the direction indicated by arrow 502. If the locking block 410 is in the released position, the support members 302 may rotate about their respective support axis 402 in the lowered direction 412 because the locking block 410 no longer interferes with the bottom portion of the rearward support member 302. Once the support members 302 are at least partially rotated in the lowered direction 412, the user may release the latch 306 and the locking block 510 may be held in the released position 500 via contact with the lower portion of the support member 302 that contacts an outer surface 504 of the locking block 410 to hold the locking block in the release position.

In one aspect of the armrest assembly described above, the pivot stop 406 may also define the angular orientation of the support members 302 in the lowered position. More specifically, the pivot stop 406 may be angled relative to a substantially horizontal plane. As the support members 302 are transitioned to the lowered position, the support arm towards the front of the chair 100 may pivot in the lowered direction 412 until it rests upon a surface of the pivot stop 406. Accordingly, the angular orientation of the forward support member 302 may be dictated by the pivot stop 406 and the angular orientation of the rearward support member 302 may be dictated by its pivotal linkage with the arm rest 116 and the pivot housing 304. A person skilled in the art would understand and appreciate herein that each support member 302 is pivotally coupled at each end and the rotation of one support member 302 necessarily requires the rotation of the other.

In another aspect of the pivot housing 304, the components coupled thereto may be substantially reversible to become positioned on either side of the chair 100. More specifically, the pivot stop 406 may be coupled to the pivot housing 304 at a central coupling location when the pivot housing 304 is on either side of the chair 100. However, the pivot housing 304 may also provide a first and second offset coupling location on either side of the central coupling location that correspond with the respective side of the chair 100 on which the pivot housing 304 is being installed. Accordingly, if the pivot housing 304 is being installed on a first side of the chair 100, the pivot stop may be coupled to the central coupling location and the first offset coupling location to allow the arm rest 116 to become oriented in the positions described above. Alternatively, if the pivot housing 304 is being installed on a second side of the chair, the pivot stop 406 may be coupled to the central coupling location and the second offset coupling location to allow the arm rest 116 to become oriented in the positions described above. Similarly, the respective support arms 302 may have multiple coupling locations defined in the pivot housing 304 to allow for the same pivot housing 304 to be utilized regardless of the side of the chair 100 on which the pivot housing is being installed.

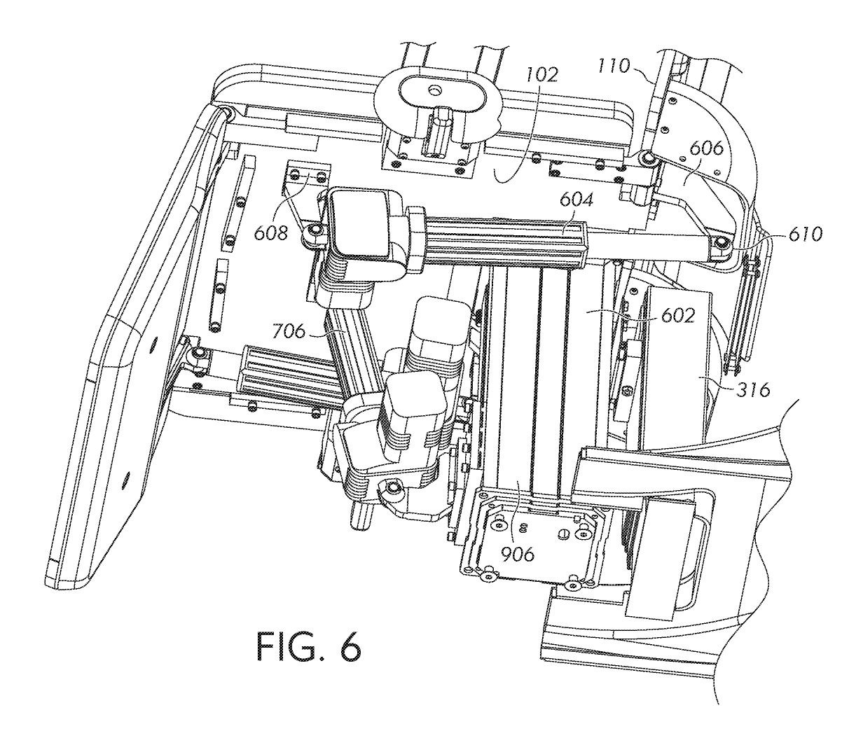

Referring now to FIG. 6, a perspective view of the internal components of the chair 100 is shown. More specifically, a pillar 602 is shown with the platform 118 and other covers removed. The pillar 602 may telescopically alter the height of the chair 100 relative to the underlying ground. Further, one or more actuators may be coupled to the components of the chair 100 to allow for further control of the positioning of the back 110, seat 102, and leg rest 112. More specifically, in one embodiment a back actuator 604 may be coupled to a portion of the seat 102 on one end 608, and to a portion of the back 110 on the other end 610. In this configuration, the length of the back actuator 604 may be selectively controlled to alter the angular orientation of the back 110 relative to the seat 102. A back bracket 606 may be coupled to a portion of the back 110 on one end and pivotally coupled to the back actuator 604 on the other end. The back bracket 606 may provide sufficient strength to allow the back actuator 604 to reposition the back 110 relative to the seat 102 when a user is sitting in the chair 100.

Referring now to FIG. 7, a leg rest actuator 702 is shown. The leg rest actuator 702 may be coupled to a portion of the seat 102 on one end and to a portion of the leg rest 112 on the other end. The leg rest actuator 702 may also be selectively repositionable to alter the angular orientation of the leg rest 112 relative to the seat 102 about a leg rest axis 704.

A seat position actuator 706 is also shown in FIG. 7. The seat position actuator 706 may be coupled to a portion of the pillar 602 on one end 712 and to a portion of the seat 102 on the other end 714. The seat position actuator 706 may also be selectively repositionable to alter the angular orientation of the seat 102 relative to the pillar 602 about a pillar axis 708. The pillar 602 extends along a pillar longitudinal axis 710, which is substantially perpendicular to the axis 708.

Accordingly, the position of the back 110 relative to the seat 102 may be altered by the back actuator 604, the position of the leg rest 112 relative to the seat 102 may be altered by the leg rest actuator 702, the position of the seat 102 relative to the pillar 602 may be altered by the seat position actuator 706, and the height of the seat 102 relative to the underlying surface may be altered by the pillar 602.

As illustrated in FIG. 7, as well as in FIG. 6, the seat position actuator 706 includes an end coupled to the pillar 602, an end 712 coupled to the pillar 602, and an end 714 coupled to the leg rest 112. The seat position actuator 706 is centrally located at the seat 100 and the leg rest actuator 702 and the back actuator 604 are located on opposite sides of the seat position actuator 706.

The actuators shown and described above can be any type of actuator known in the art. More specifically, electric actuators, hydraulic actuators, pneumatic actuators and the like could be used. Similarly, any other similar assembly could be used. In one embodiment, a scissor jack or similar rotational jack could be used. Accordingly, this disclosure is not limited to any particular type of actuator or device used to reposition the components described above.

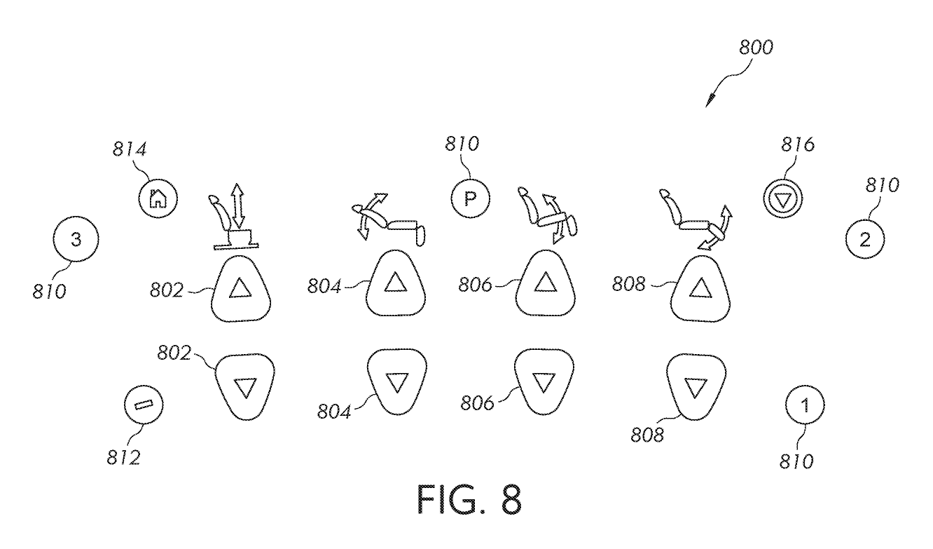

Now referring to FIG. 8, a control button layout 800 is shown. More specifically, the control button layout 800 may have a plurality of buttons that may send commands to a controller or directly to an actuator to reposition the chair 100 as desired by the user. In one embodiment, the control button layout 800 may have a chair up and a chair down button 802. The chair up/down buttons 802 may control an actuator within the pillar 602 to alter the height of the chair 100 relative to the underlying ground. The chair up/down buttons 802 may have a first button that raises the chair 100 and a second button that lowers the chair 100.

The control button layout 800 may also have a back up and a back down button 804. The back up/down buttons 804 may control the back actuator 604 to alter the position of the back 110 of the chair 100 relative to the seat 102. The back up/down buttons 804 may have a first button that pivots the back 110 away from the seat 102 and a second button that pivots the back 110 towards the seat 102.

The control button layout 800 may also have a tilt up and a tilt down button 806. The tilt up/down buttons 806 may control the seat position actuator 706 to alter the position of the seat 102 of the chair 100 relative to the seat pillar 602 and in turn relative to the underlying surface. The tilt up/down buttons 806 may have a first button that tilts the seat 110 towards the back 110 and a second button that tilts the seat 102 towards the leg rest 112. The tilt up/down buttons 806 may also tilt the back 110 and the leg rest 112 along with the seat 102. More specifically, because the leg rest actuator 702 and the back actuator 604 are coupled to the seat 102, as the seat 102 tilts, the leg rest 112 and the back 110 will also tilt therewith.

The control button layout 800 may also have a leg rest up and a leg rest down button 808. The leg rest up/down buttons 808 may control the leg rest actuator 702 to alter the position of the leg rest 112 of the chair 100 relative to the seat 102. The leg rest up/down buttons 808 may have a first button that pivots the leg rest 112 away from the platform 118 and a second button that pivots the leg rest 112 towards the platform 118.

The control button layout 800 may also have one or more program buttons 810, a Trendelenburg button 812, and a home button 814. The program buttons 810 may be selectable by a user to reposition the chair 100 to a previously stored position. More specifically, the user may utilize the chair up/down buttons 802, the back up/down buttons 804, the tilt up/down buttons 806, and the leg rest up/down buttons 808 to position the chair 100 in any desirable position. Once the user has the chair 100 positioned how desired, the user may program that position into one of the program buttons 810. The particular orientation of the chair 100 may be saved into a memory unit and the respective program button 810 may return the chair 100 to that position whenever selected by the user.

Similarly, the Trendelenburg button 812 may automatically utilize the actuators described above to orient the chair 100 in the Trendelenburg position. The home button 814 may be selected by the user to return the chair to a home position. A lockout button 816 is also provided.

In one embodiment, the control button layout 800 may be positioned on a hand controller for the user to manipulate. The hand controller may communicate with the chair 100, either via wires or any known wireless method, to reposition the chair as instructed. Alternatively or additionally, the control layout 800 may be positioned on foot switches for the user to manipulate. The foot switches may also communicate with the chair 100, either via wires or any known wireless method, to reposition the chair as instructed.

While buttons 802-816 have been shown and described above, this disclosure is not limited to using buttons. More specifically, in one embodiment a touch screen or other similar device may be used. Further still, in one embodiment a control system may be installed on any type of computing device to control the position of the chair 100. More specifically, a desktop computer, cell phone, tablet, laptop, or the like may have a control system installed thereon that allows the device to control the positioning if the chair 100.

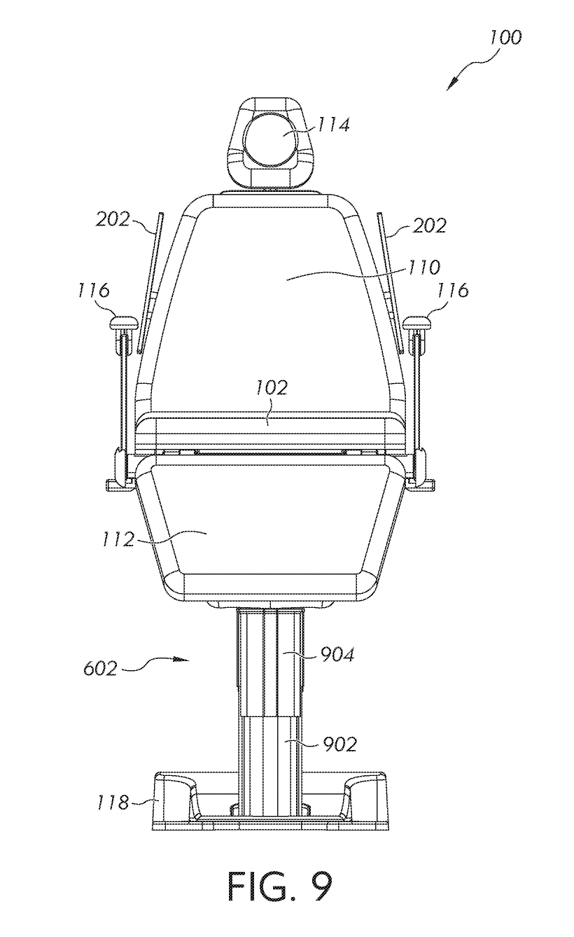

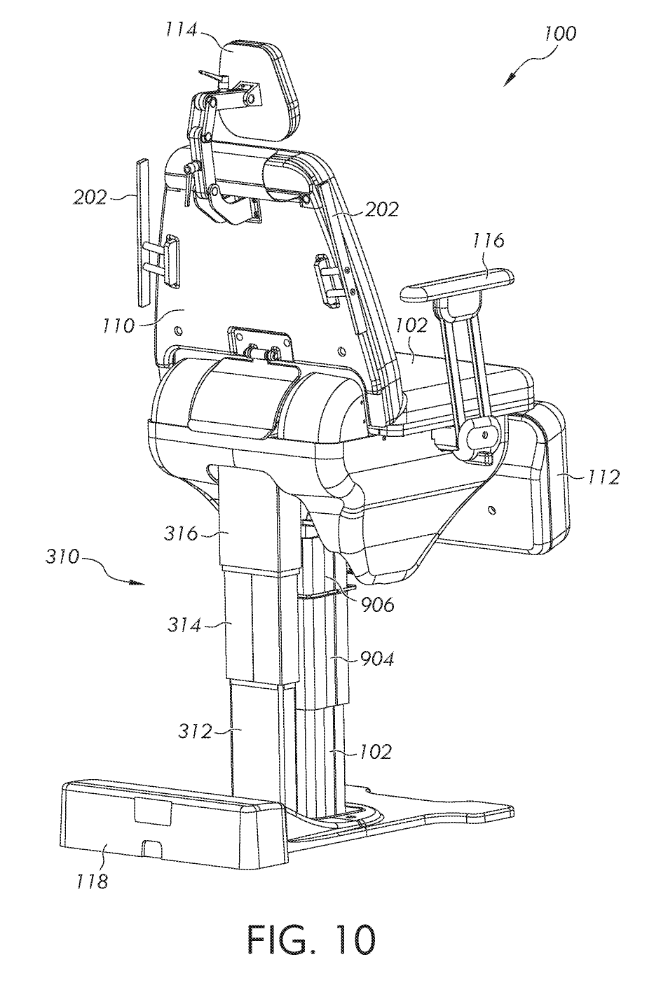

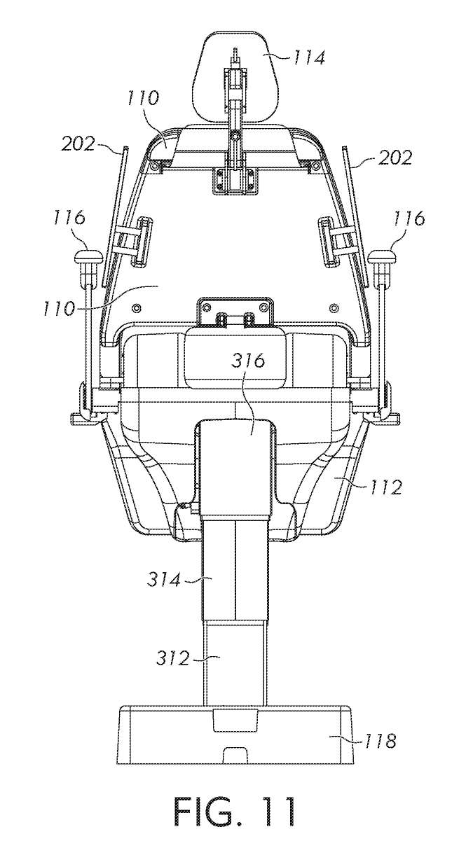

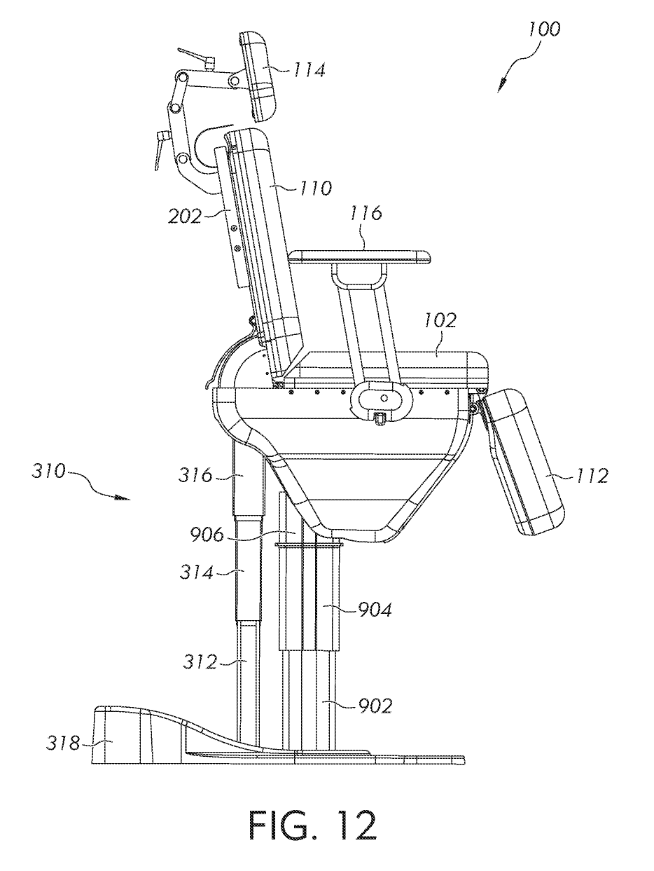

FIGS. 9, 10, 11 and 12 illustrate the chair 100 at an elevated position with the pillar 602 and the housing 310 located in an extended position. As seen in FIGS. 2 and 3, each of the housing 310 and the pillar 602 are in a collapsed position. The housing 310 and the pillar 602 are adjacently located which reduces the area needed to support the chair with the platform 118. The reduced area along with the configuration of the contoured edge 120 increases the amount of area available for medical personnel providing a procedure to an individual supported by the chair.

The pillar 602 includes a plurality of supports including a first support 902, a second support 904, and a third support 906. To move the chair up and or down, the buttons 802 control the actuator within the pillar 602 to alter the height of the chair 100 relative to the platform 118. Since the seat actuator 706 is coupled to the third support 906, as the actuator extends the pillar 602 from a lowest position to an extended position, movement of the third support 906 elevates the seat with respect to the platform 118.

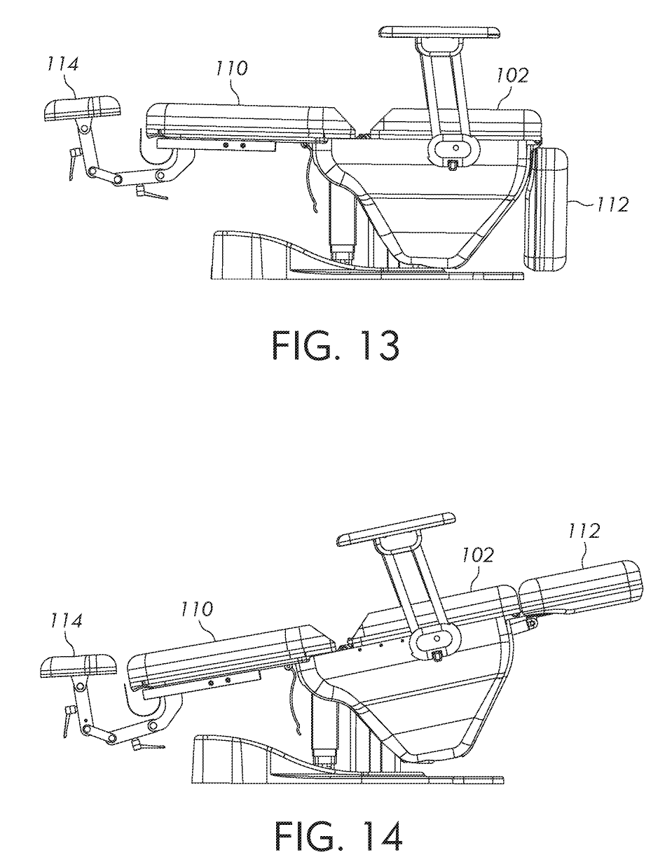

FIG. 13 illustrates another position of the chair 100 using the control button layout 800. In this position, the chair back button 804 is used to move the back 110 into planar alignment with the seat 102. The leg rest 112 is located in a down position with the leg rest buttons 808.

FIG. 14 illustrates the Trendelenburg position of the chair 100. This position is selected with the Trendelenburg button 812. In one embodiment, the button 812 sets the Trendelenburg position to a 15 degree incline. In this position, the back 110, the seat 102, and the leg rest 112 provide a planar support surface, but angled at a head down position.

While exemplary embodiments incorporating the principles of the present disclosure have been disclosed herein, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this invention pertains.

The terminology used herein is for the purpose of describing particular illustrative embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations)

Attached hereto and included with this application is an addendum including various additional descriptions and drawings depicting further aspects of some of the embodiments of the present disclosure. These attached materials are intended to comprise part of this application, and as such, their contents are hereby expressly incorporated by reference in their entirety herein.

What is claimed is:

1. A medical chair having a plurality of adjustable positions comprising:
a platform configured to support the medical chair;
a seat operatively connected to the platform;
a leg rest pivotably coupled to the seat;
a back pivotably coupled to the seat;
a pillar including a plurality of supports, in which a first one of the supports is fixedly coupled to the platform and a second one of the supports is operatively coupled to the seat, wherein in a first position of the seat with respect to the platform, the plurality of supports are nested to position the seat at a lowest height and in a second position the plurality of supports are extended to position the seat at a highest height; and
a leg rest actuator rotatably coupled to the leg rest, a back actuator rotatably coupled to back rest, and a seat position actuator is fixedly coupled to one of the plurality of supports of the pillar and rotatably coupled to the seat.

2. The medical chair of claim 1 wherein the leg rest actuator is operatively connected to the seat.

3. The medical chair of claim 2 wherein the back actuator is operatively coupled to the seat.

4. The medical chair of claim 1 wherein the plurality of supports telescopically alters the height of the seat with respect to the platform.

5. The medical chair of claim 1 wherein the seat position actuator is centrally located on the seat and the leg rest actuator and the back actuator are located on opposite sides of the seat position actuator.

6. The medical chair of claim 5 wherein the seat position actuator is selectively repositionable to alter the angular orientation of the seat relative to the pillar.

7. The medical chair of claim 1 wherein each of the plurality of supports of the pillar are aligned along a longitudinal axis substantially perpendicular to a lateral axis defined by the pillar.

8. The medical chair of claim 7 wherein the plurality of supports of the pillar includes at least three supports, wherein the first one of the supports is an innermost support fixedly coupled to the platform and the second one of the supports is an outermost support fixedly coupled to the seat position actuator, and a third one of the support is a middle support located between the innermost support and the outermost support.

9. The medical chair of claim 8 further comprising an actuator located within the pillar configured to alter the height of the chair.

10. The medical chair of claim 1 wherein the platform defines a contoured edge which extends along a longitudinal axis of the medical chair including a first portion located more closely to the longitudinal axis than a second portion is located to the longitudinal axis.

11. The medical chair of claim 4 wherein the second portion includes a first end disposed toward the leg rest and a second end disposed behind the back, wherein the second end includes a raised portion.

12. The medical chair of claim 1 further comprising a linked cable carrier located within a housing, wherein the housing extends from the platform toward the seat and is disposed adjacently to the pillar.

13. The medical chair of claim 12 wherein the housing includes at least two housing pieces, wherein the two housing pieces extend telescopically as the seat is located at the second position from the first position.

14. A medical chair having a plurality of adjustable positions comprising:
a seat;
a platform configured to support the seat;
a pillar including a plurality of nested supports, in which a first one of the supports is fixedly coupled to the platform and a second one of the supports is operatively coupled to the seat, wherein the nested supports extend telescopically as the seat is positioned with respect to the platform; and
a linked cable carrier located within a housing, wherein the housing extends from the platform toward the seat and is disposed adjacently to the pillar.

15. The medical chair of claim 14 wherein the plurality of supports of the pillar includes at least three supports, wherein the first one of the supports is an innermost support fixedly coupled to the platform and the second one of the supports is an outermost support fixedly coupled to the seat, and a third one of the supports is a middle support located between the innermost support and the outermost support.

16. The medical chair of claim 15 wherein the housing includes at least two housing pieces, wherein the housing extends telescopically with respect to the platform.

17. The medical chair of claim 16 further comprising:
a leg rest pivotably coupled to the seat;
a back pivotably coupled to the seat;
a leg rest actuator rotatably coupled to the leg rest, a back actuator rotatably coupled to back rest, and a seat position actuator is fixedly coupled to the outermost support of the plurality of supports and rotatably coupled to the seat.

18. The medical chair of claim 17 wherein the seat position actuator is centrally located on the seat and the leg rest actuator and the back actuator are located on opposite sides of the seat position actuator.

19. The medical chair of claim 18 wherein the platform defines a contoured edge which extends along a longitudinal axis of the medical chair including a first portion located more closely to the longitudinal axis than a second portion is located to the longitudinal axis.

20. The medical chair of claim 19 wherein the second portion includes a first end disposed toward the leg rest and a second end disposed behind the back, wherein the second end includes a raised portion.
